(19) United States
(12) Patent Application Publication
(10) Pub. No.: US 2013/0036389 A1
(43) Pub. Date: Feb. 7, 2013

(54) COMMAND ISSUING APPARATUS, COMMAND ISSUING METHOD, AND COMPUTER PROGRAM PRODUCT

(71) Applicants: Hidetaka Ohira, Tokyo (JP); Ryuzo Okada, Kanagawa (JP); Yojiro Tonouchi, Tokyo (JP); Tsukasa Ike, Tokyo (JP); Toshiaki Nakasu, Tokyo (JP)

(72) Inventors: Hidetaka Ohira, Tokyo (JP); Ryuzo Okada, Kanagawa (JP); Yojiro Tonouchi, Tokyo (JP); Tsukasa Ike, Tokyo (JP); Toshiaki Nakasu, Tokyo (JP)

(73) Assignee: KABUSHIKI KAISHA TOSHIBA, Tokyo (JP)

(21) Appl. No.: 13/526,777

(22) Filed: Jun. 19, 2012

(30) Foreign Application Priority Data
Aug. 5, 2011 (JP) 2011-171744

(51) Int. Cl. G06F 3/033

(52) U.S. Cl. 715/863

(57) ABSTRACT

According to an embodiment, a command issuing apparatus includes an acquiring unit configured to acquire an image obtained by capturing a subject; a detector configured to detect a specific region of the subject from the image; a first setting unit configured to set a specific position indicating a position of the specific region; a second setting unit configured to set a reference position indicating a position that is to be a reference in the image; a first calculator configured to calculate a position vector directing toward the specific position from the reference position; a second calculator configured to calculate, for each of a plurality of command vectors respectively corresponding to predetermined commands, a first parameter indicating a degree of coincidence between the command vector and the position vector; and an issuing unit configured to issue the command based on the first parameter.

### CROSS-REFERENCE TO RELATED APPLICATION(S)

This application is based upon and claims the benefit of priority from Japanese Patent Application No. 2011-171744, filed on Aug. 5, 2011; the entire contents of which are incorporated herein by reference.

### FIELD

Embodiments described herein relate generally to a command issuing apparatus, a command issuing method, and a computer program product.

### BACKGROUND

There has been known a command issuing apparatus that issues a command according to a motion of a specific region (e.g., a hand) of a user. In such a command issuing apparatus there has been known a technique in which, when the current moving speed of the specific region exceeds a reference speed, the command issuing apparatus detects that the current motion of the specific region is a fast motion, and determines whether or not the current state of the specific region is a feeding action for issuing a predetermined command, from the relationship between the fast motion and a fast motion detected immediately before the current fast motion.

However, when an action (returning action) of moving the specific region in the direction reverse to the direction of the feeding action in which the user's hand moves in a predetermined direction so as to return the specific region to the original position is detected as the fast motion, a new command might be issued according to the returning action in the above-mentioned technique.

### BRIEF DESCRIPTION OF THE DRAWINGS

FIG. 1 is a block diagram illustrating a command issuing apparatus according to a first embodiment;

FIG. 2 is a view illustrating one example of a frame;

FIG. 3 is a view illustrating one example of a frame;

FIG. 4 is a flowchart illustrating an example of a process operation performed by the command issuing apparatus;

FIG. 5 is a block diagram illustrating a command issuing apparatus according to a second embodiment;

FIG. 6 is a flowchart illustrating an example of a process operation performed by the command issuing apparatus;

FIG. 7 is a block diagram illustrating a command issuing apparatus according to a third embodiment;

FIG. 8 is a flowchart illustrating an example of a process operation by the command issuing apparatus;

FIG. 9 is a block diagram illustrating a command issuing apparatus according to a fourth embodiment;

FIG. 10 is a view illustrating an example of a display of a command input state;

FIG. 11 is a view illustrating an example of a display of a command input state;

FIG. 12 is a view illustrating an example of a display of a command input state;

FIG. 13 is a view illustrating an example of a display of a command input state;

FIG. 14 is a flowchart illustrating an example of a process operation performed by the command issuing apparatus;

FIG. 15 is a block diagram illustrating a command issuing apparatus according to a modification; and

FIG. 16 is a block diagram illustrating a command issuing apparatus according to a modification.

### DETAILED DESCRIPTION

According to an embodiment, a command issuing apparatus includes an acquiring unit configured to acquire an image obtained by capturing a subject; a detector configured to detect a specific region of the subject from the image; a first setting unit configured to set a specific position indicating a position of the specific region; a second setting unit configured to set a reference position indicating a position that is to be a reference in the image; a first calculator configured to calculate a position vector directing toward the specific position from the reference position; a second calculator configured to calculate, for each of a plurality of command vectors respectively corresponding to predetermined commands, a first parameter indicating a degree of coincidence between the command vector and the position vector; and an issuing unit configured to issue the command based the first parameter.

Various embodiments will be described below with reference to the accompanying drawings.

### First Embodiment

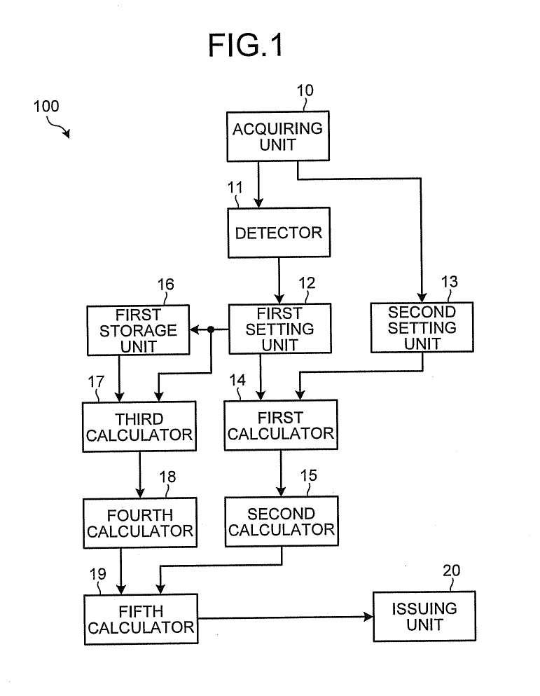

FIG. 1 is a block diagram illustrating a configuration example of a command issuing apparatus 100 according to a first embodiment. As illustrated in FIG. 1, the command issuing apparatus 100 includes an acquiring unit 10, a detector 11, a first setting unit 12, a second setting unit 13, a first calculator 14, a second calculator 15, a first storage unit 16, a third calculator 17, a fourth calculator 18, a fifth calculator 19, and an issuing unit 20.

The acquiring unit 10 sequentially acquires an image (each image is referred to as a “frame”) captured by an unillustrated imaging device at a predetermined interval (frame cycle). The imaging device can be configured by a CMOS image sensor, an infrared image sensor, a range image sensor, or a moving-image reproducing device, for example.

The detector 11 executes a detecting process for detecting a specific region of a subject (e.g., a user) from the frame acquired by the acquiring unit 10. The specific region is preferably detected, every time the frame is acquired. However, the specific region may be detected at regular intervals according to the processing capacity of the apparatus. In the first embodiment, a user's hand is employed as the specific region. However, the embodiment is not limited thereto. Any specific region may be set. For example, at least a part of a body of the user, such as a hand or leg, can be employed as the specific region. An object, whose pattern image is preliminarily registered, such as a controller that can be operated in air, or colored ball, can be employed as the specific region. Any method can be employed as the method of detecting the specific region, and various known techniques can be used. For example, a pattern recognition method, a background differencing technique, a skin-color detection method, or an inter-frame differential method, or a combination of these methods can be used.

The first setting unit 12 sets a specific position indicating a position of the detected specific region, every time the detector 11 detects the specific region. For example, the first setting unit 12 in the first embodiment sets a coordinate at the center of the specific region in the frame detected by the detector 11 as the specific position.

Every time the detector 11 detects the specific region, the second setting unit 13 sets a reference position indicating a position that is to be a reference in the current frame. In the first embodiment, a position of a user's shoulder is employed as the reference position. The second setting unit 13 detects the position of a user's face from the frame acquired by the acquiring unit 10, and specifies the position of the shoulder based upon the detected face position. The second setting unit 13 then sets the specified shoulder position as the reference position. Any method may be used as the method of detecting the user's face position and the method of detecting the user's shoulder position, and various known techniques can be employed.

Although the user's shoulder position is set as the reference position in the first embodiment, the embodiment is not limited thereto. Any reference position can be set. For example, a predetermined camera coordinate or a world coordinate can also be employed as the reference position. At least a part of a user's body, such as a hand or leg, can also be employed as the reference position. A position of an object, whose pattern image is preliminarily registered, such as a controller that can be operated in air, or colored ball, can be employed as the reference position. The position of the region where the specific region (e.g., user's hand) is first detected in the frame can also be employed as the reference position.

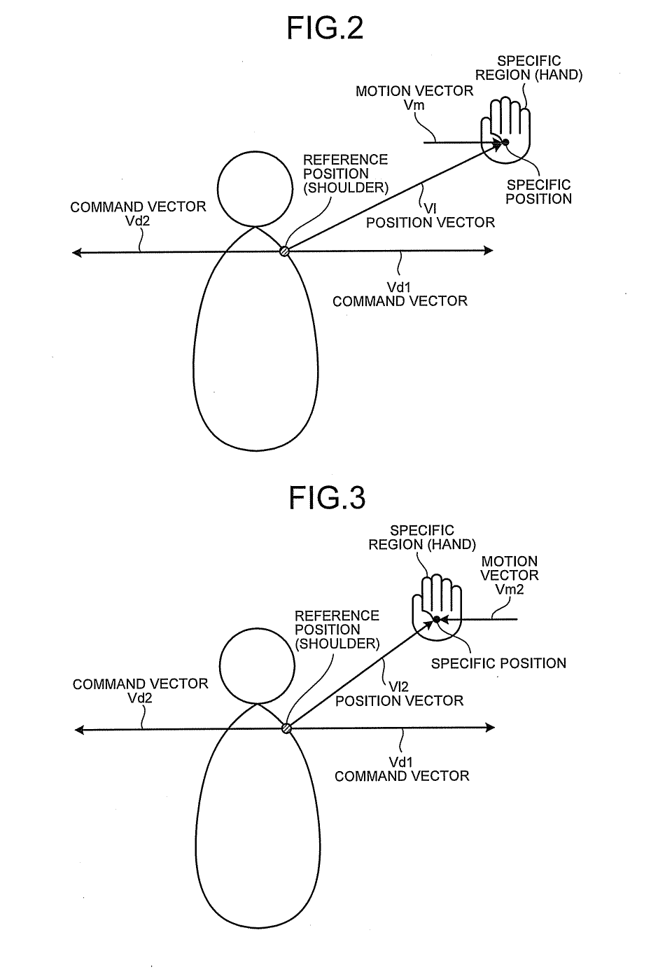

The first calculator 14 calculates a position vector directing toward the specific position from the reference position. More specifically, the first calculator 14 calculates a position vector by using the reference position and the specific position in the current frame, every time the detector 11 detects the specific region. For example, when a frame illustrated in FIG. 2 is acquired, the position vector calculated by the first calculator 14 is indicated as V1 in FIG. 2.

For each of a plurality of command vectors respectively corresponding to predetermined commands, the second calculator 15 calculates a first parameter indicating a degree of coincidence between the command vector and the position vector calculated by the first calculator 14. For example, an inner product of the command vector and the position vector is employed as the first parameter in the first embodiment, and therefore, the first parameter has a greater value, as the degree of coincidence between the command vector and the position vector is higher. However, the embodiment is not limited thereto. The first parameter may be any value, so long as it indicates the degree of coincidence between the command vector and the position vector. Every time the detector 11 detects the specific region, the second calculator 15 in the first embodiment calculates the first parameter of each command vector. In FIG. 2, an inner product of a command vector Vd1 corresponding to a predetermined command and a position vector V1 is larger than an inner product of a command vector Vd2 corresponding to another command and the position vector V1.

Any method may be employed as the method of calculating the first parameter. For example, the first parameter can be calculated by using a non-linear function such as formula (1) below. Specifically, in this formula, if a distance x between the specific position and the reference position falls within a predetermined range c, the first parameter is set to be b that is a sufficiently low value, while if the distance x exceeds the predetermined range c, the first parameter is set to be a that is a sufficiently high value. In this case, the user can easily find at which position the specific region is to be present as viewed from the reference position in order to set the first parameter of the command vector, corresponding to the command that the user intends to issue, to have a sufficiently large value.

Ppos=a if x>c

Ppos=b otherwise (1)

In formula (1), Ppos indicates the first parameter.

The function for calculating the first parameter of each command vector may be a linear function. For example, the relationship between the distance x between the specific position and the reference position and the first parameter may be represented by a linear function. In this case, the value of the first parameter is proportional to the distance x. Alternatively, the relationship between the first parameter and the distance x may be represented by a linear function such as quadratic function, sigmoid function, exponential function, logarithm function, or kernel function (e.g., Gaussian kernel). In this case, as the distance x becomes larger, the value of the first parameter becomes larger, and further, the increasing rate becomes smoother. Therefore, compared to the case where the first parameter is obtained by using the non-linear function such as formula (1), the first parameter can be set to a value according to an intention of the user. For example, the relationship between the first parameter and the distance x can be represented by formula (2) below. Formula (2) is a combination of the functions described above.

Ppos=ax^{d} if x>c

Ppos=bx^{e} otherwise (2)

For example, the relationship between the first parameter and the distance x can be represented by formula (3) below. Formula (3) is expressed by a non-linear function in which, as the value becomes larger in proportion to the distance x, and when the distance x becomes equal to or larger than a predetermined value, the increasing rate of the first parameter is changed.

Ppos=a log(dx) if x>c

Ppos=b log(ex) otherwise (3)

The first storage unit 16 illustrated in FIG. 1 stores therein the specific position set by the first setting unit 12. More specifically, every time the detector 11 detects the specific region, the specific position, indicating the position of the detected specific region, is sequentially (in chronological order) stored in the first storage unit 16. The third calculator 17 calculates a motion vector representing the moving direction and the moving amount of the specific region based upon the history of the specific position stored in the first storage unit 16. For example, in the first embodiment, every time the detector 11 detects the specific region, the third calculator 17 calculates the motion vector in the current frame from the specific position set by the first setting unit 12 and the previous specific position stored in the first storage unit 16. In FIG. 2, the motion vector calculated by the third calculator 17 is represented as Vm. The embodiment is not limited thereto. Any method may be employed as the method of calculating the motion vector, so long as the moving direction and the moving amount of the specific region can be specified.

The fourth calculator 18 calculates a second parameter indicating a degree of coincidence between the command vector and the motion vector calculated by the third calculator 17 for each command vector. For example, in the first embodiment, an inner product of the command vector and the motion vector is employed as the second parameter, and therefore, as the degree of coincidence between the command vector and the motion vector is higher, the second parameter has a larger value. The embodiment is not limited thereto. The second parameter may be any value, so long as it indicates the degree of coincidence between the command vector and the motion vector. Every time the detector 11 detects the specific region, the fourth calculator 18 in the first embodiment calculates the second parameter of each command vector in the current frame. In FIG. 2, the inner product of the command vector Vd1 and the motion vector Vm is larger than that of the command vector Vd2 and the motion vector Vm.

The fifth calculator 19 illustrated in FIG. 1 calculates a third parameter, for each command vector, based upon the first parameter and the second parameter of the command vector. The third parameter has a larger value, as the values of the first parameter and the second parameter are larger. Every time the first parameter and the second parameter of each command vector are calculated, the third parameter of the command vector is calculated. For example, in the first embodiment, the third parameter is represented as a sum of the first parameter and the second parameter. With this, even when the position vector is small because the specific position is in the vicinity of the reference position, and therefore, the first parameter has a small value, the value of the third parameter of the command vector can be increased by moving the specific region faster or by moving the specific region in the direction of the command vector corresponding to the command that the user intends to issue. When the specific position is sufficiently far from the reference position, and therefore, the position vector has a large value, the value of the third parameter of the command vector can be increased, even if the moving speed of the specific region is slow, and the moving amount in the direction of the command vector corresponding to the command that the user intends to issue is small.

Alternatively, for example, the value obtained by multiplying the first parameter and the second parameter can be used as the third parameter. In this case, the third parameter of the command vector has a large value only when the degree of coincidence between the command vector and the position vector is high and the degree of the coincidence between the command vector and the motion vector is high. Still alternatively, the smaller one of the first parameter and the second parameter can be calculated as the third parameter. Furthermore, the value obtained by combining the sum of the first parameter and the second parameter and the product of the first parameter and the second parameter can be calculated as the third parameter. In this case, if the second parameter, which indicates the degree of coincidence between the command vector corresponding to a predetermined command and the motion vector, has a large value due to the execution of the operation of issuing the predetermined command, the value of the third parameter of the command vector can be increased even if the specific position is near the reference position or the specific position is apart from the reference position.

The issuing unit 20 issues a command based upon the third parameter calculated by the fifth calculator 19. More specifically, when the value of the third parameter of each of the command vectors is equal to or larger than a threshold value, the issuing unit 20 issues a command corresponding to the command vector. The threshold value can be set to any value. In FIG. 2, when the value of the third parameter (i.e., the sum of the first parameter, indicating the inner product of the command vector Vd1 and the position vector V1, and the second parameter, indicating the inner product of the command vector Vd1 and the motion vector Vm) of the command vector Vd1 is equal to or larger than the threshold value, the issuing unit 20 issues a command corresponding to the command vector Vd1. In order to prevent misdetection, when the value of the third parameter of a certain command vector is equal to or larger than the threshold value over a predetermined number of frames, the command corresponding to the command vector may be issued.

It is supposed here that the user makes a returning action (the action of moving his/her hand in the direction reverse to the direction of the command vector Vd1 to return his/her hand to the original position) from the state in FIG. 2. In this case, it is supposed that a frame illustrated in FIG. 3 is acquired as the next frame of the frame illustrated in FIG. 2. Since the direction of the motion vector Vm2 in the frame in FIG. 3 is reverse to the direction of the command vector Vd1, the second parameter indicating the inner product of the command vector Vd1 and the motion vector Vm2 has a minus value. Furthermore, since the position (specific position) of the user's hand gets close to the shoulder position (reference position), the position vector V12 in the frame in FIG. 3 becomes smaller than the position vector V11 in FIG. 2. Accordingly, the value of the third parameter of the command vector Vd1 becomes smaller than that in FIG. 2.

Since the direction of the motion vector Vm2 in the frame in FIG. 3 coincides with the direction of the command vector Vd2, the second parameter indicating the inner product of the command vector Vd2 and the motion vector is increased more than that in the example in FIG. 2. However, the first parameter indicating the inner product of the command vector Vd2 and the position vector V12 in the frame in FIG. 3 has a minus value, which can prevent the third parameter of the command vector Vd2 from having a value equal to or larger than the threshold value. Specifically, the command that the user does not intend to issue (in this example, the command corresponding to the command vector Vd2) is not issued by the returning action, and the feeding action and the action (e.g., returning action) different from the feeding action can be distinguished.

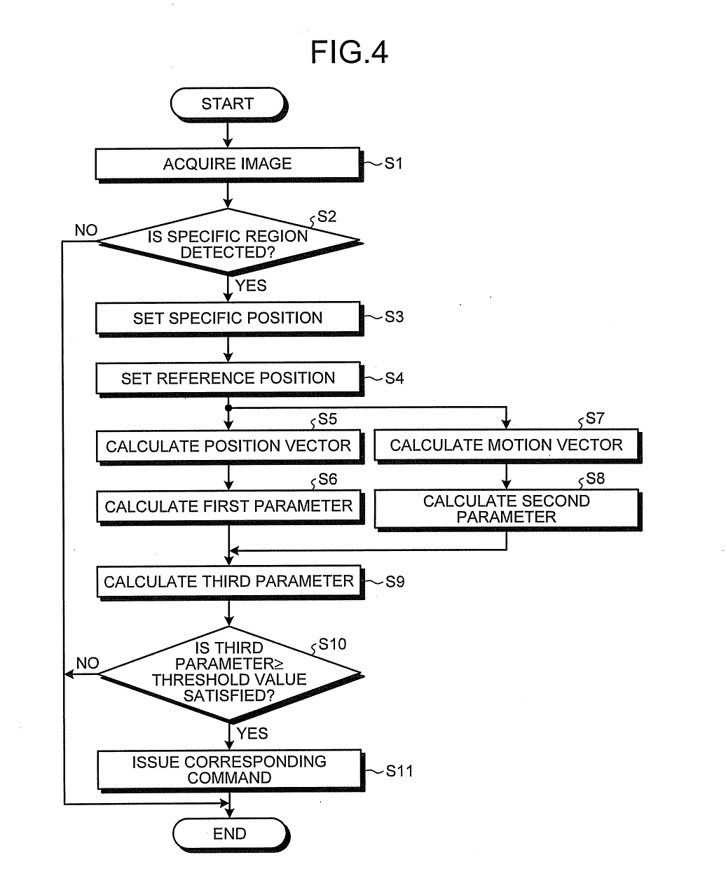

Next, one example of a process operation performed by the command issuing apparatus 100 according to the first embodiment will be described. FIG. 4 is a flowchart illustrating one example of the process operation performed by the command issuing apparatus 100. As illustrated in FIG. 4, when a frame is acquired by the acquiring unit 10 (step S1), the detector 11 executes a detecting process of detecting a specific region (e.g., a user's hand) of a subject from the acquired frame. When the detector 11 detects the specific region (result of step S2: YES), the first setting unit 12 sets a specific position indicating the position of the detected specific region (step S3). The second setting unit 13 sets a reference position indicating a position that is to be a reference from the frame acquired in step 51 (step S4). In the first embodiment, a shoulder position of the user is employed as the reference position. The second setting unit 13 detects the face position of the user from the frame, and specifies the shoulder position of the user based upon the detected face position. Then, the second setting unit 13 sets the specified shoulder position as the reference position.

After step S4, the first calculator 14 calculates the position vector in the frame acquired in step Si (step S5). Then, the second calculator 15 calculates the first parameter, indicating the degree of coincidence between the command vector and the position vector calculated in step S5, for each command vector (step S6).

After step S4, the third calculator 17 calculates a motion vector in the frame acquired in step Si from the specific position specified in step S3 and the previous specific position stored in the first storage unit 16 (step S7). The fourth calculator 18 calculates the second parameter, indicating the degree of coincidence between the command vector and the motion vector calculated in step S7, for each command vector (step S8).

Next, the fifth calculator 19 calculates the third parameter based upon the first parameter and the second parameter of the command vector for each command vector (step S9). As described above, in the first embodiment, the third parameter is calculated by adding up the first parameter and the second parameter of the command vector for each command vector. Then, the issuing unit 20 determines whether the third parameter calculated in step S9 is equal to or larger than a threshold value or not (step S10). More specifically, the issuing unit 20 determines for each command vector whether the value of the third parameter (the third parameter calculated in step S9) of the command vector is equal to or larger than the threshold value or not. When the value of the third parameter calculated in step S9 is equal to or larger than the threshold value (the result of step S10: YES), the issuing unit 20 issues a command corresponding to the command vector (step S11).

As described above, in the first embodiment, the third parameter represented by the sum of the first parameter, indicating the degree of coincidence between the command vector and the position vector, and the second parameter, indicating the degree of coincidence between the command vector and the motion vector, is calculated for each command vector, and a command is issued based upon the calculated third parameter. Therefore, when the degree of coincidence between the command vector and the position vector is low even if the degree of coincidence between the command vector and the motion vector is high, the command corresponding to the command vector is difficult to be issued. For example, when the user moves his/her hand in the direction of the command vector corresponding to a predetermined command so as to issue the predetermined command, and then, makes a returning action of returning his/her hand to the original position, the user's hand moves in the direction reverse to the direction of the command vector. With this, the degree of coincidence between the motion vector and the command vector in the direction reverse to the direction of the target command vector becomes high, however; if the degree of coincidence between the command vector in the direction reverse to the direction of the target command vector and the position vector is low, the command corresponding to the command vector in the direction reverse to the direction of the target command vector is difficult to be issued. Accordingly, the first embodiment can distinguish the feeding action from the action other than the feeding action, such as the returning action and preliminary action, thereby being capable of issuing a command on which the user's intention is reflected.

### Second Embodiment

A second embodiment will next be described. The second embodiment is different from the first embodiment in that the third parameter calculated by the fifth calculator 19 is corrected based upon the previous third parameter. The same components as those in the first embodiment are identified by the same numerals and the description thereof will not be repeated.

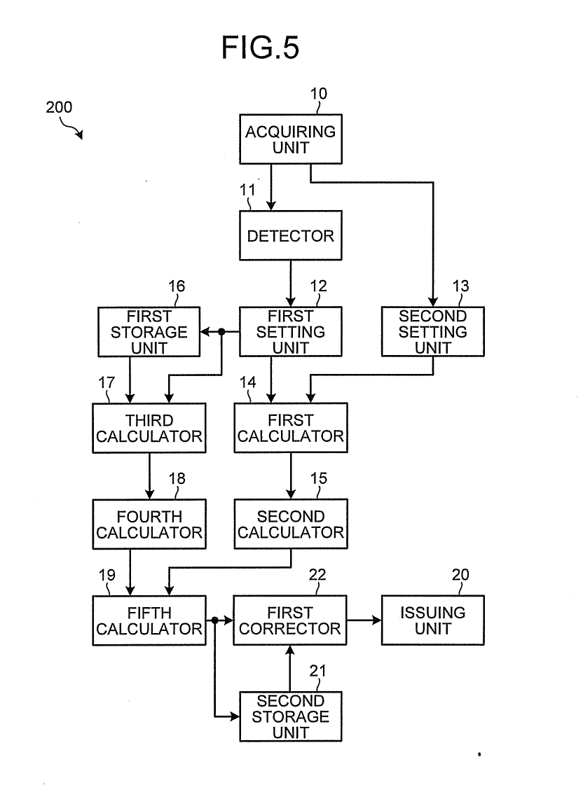

FIG. 5 is a block diagram illustrating a configuration example of a command issuing apparatus 200 according to the second embodiment. As illustrated in FIG. 5, the command issuing apparatus 200 further includes a second storage unit 21 and a first corrector 22. The second storage unit 21 stores therein the third parameter (the third parameter before the correction) calculated by the fifth calculator 19.

Every time the third parameter is calculated by the fifth calculator 19, the first corrector 22 corrects the calculated third parameter by using the previous third parameters (a history of the third parameter) stored in the second storage unit 21. For example, when the third parameter is calculated by the fifth calculator 19, the first corrector 22 can correct the calculated third parameter by obtaining an average of the calculated third parameter and at least one of the third parameters (the previous third parameters stored in the second storage unit 21) during a predetermined period in the past, or by multiplying the calculated third parameter by at least one of the third parameters. This process can prevent the third parameter from having an unintentional value due to a detection error in the specific region or the reference position.

When the third parameter is calculated by the fifth calculator 19, the first corrector 22 adds a bias value according to the previous third parameters stored in the second storage unit 21 to the calculated third parameter. The calculated third parameter can also be corrected by adding the bias value. For example, when the value of the third parameter of a specific command vector has the highest value in a predetermined period in the past, the bias value by which the value of the third parameter of the specific command vector increases can be added to the third parameter calculated by the fifth calculator 19. With this process, the command corresponding to the specific command vector is easy to be issued. Specifically, it is easy for even a small hand waving action or a hand waving action near the reference position to issue the command corresponding to the specific command vector, whereby the user can more easily make a continuous scroll motion.

For example, the user moves his/her hand near the reference position to make the returning action, whereby the inner product between the position vector and the command vector in the direction reverse to the direction of the specific command vector is changed to a plus value. Even if the value of the first parameter of the command vector in the reverse direction is changed to a plus value, a bias value by which the value of the third parameter of the specific command vector increases is added to the calculated value of the third parameter of the command vector in the reverse direction. Specifically, the third parameter of each of the command vectors other than the command vector corresponding, to the specific command is corrected (is suppressed to be low) in order to prevent the third parameter from having a value equal to or larger than the threshold value, which prevents the returning action from being erroneously recognized as the command in the reverse direction.

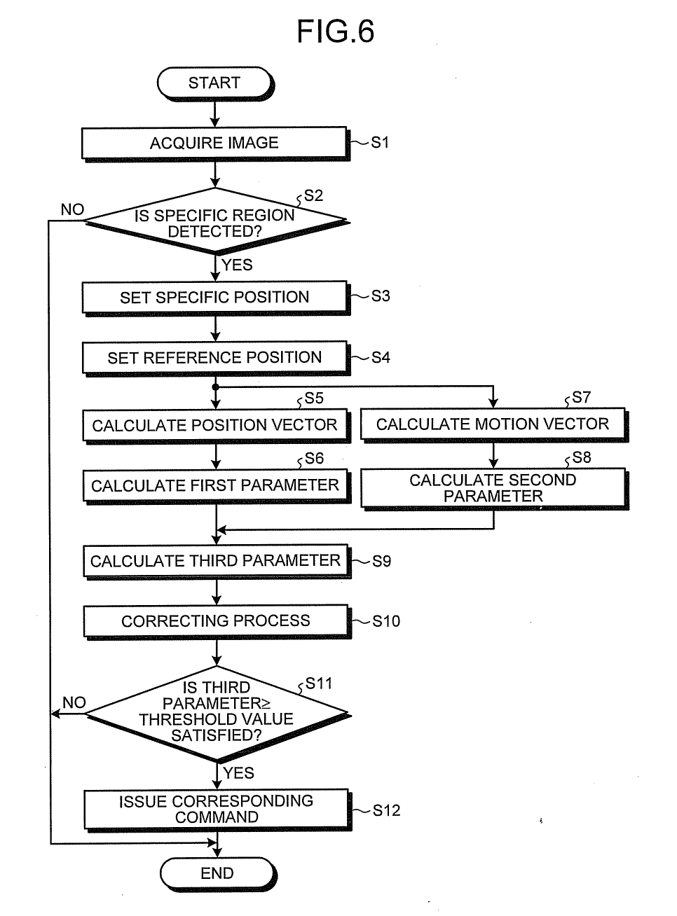

FIG. 6 is a flowchart illustrating an example of a process operation performed by the command issuing apparatus 200 according to the second embodiment. In the example in FIG. 6, the second embodiment is different from the first embodiment in that the first corrector 22 executes the above-mentioned correcting process (step S10 in FIG. 6) to the third parameter calculated in step S9. The other processes are the same as those of the first embodiment.

### Third Embodiment

A third embodiment will next be described. The third embodiment is different from the first embodiment in that the third parameter calculated by the fifth calculator 19 is corrected based upon the history of the commands issued in the past. The same components as those in the first embodiment are identified by the same numerals and the description will not be repeated.

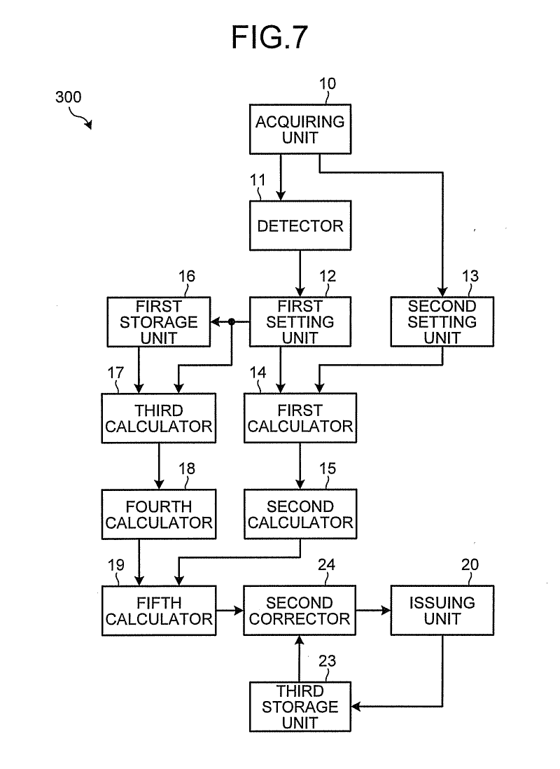

FIG. 7 is a block diagram illustrating a configuration example of a command issuing apparatus 300 according to the third embodiment. As illustrated in FIG. 7, the command issuing apparatus 300 further includes a third storage unit 23 and a second corrector 24. The third storage unit 23 stores therein the command issued by the issuing unit 20.

Every time the third parameter is calculated by the fifth calculator 19, the second corrector 24 corrects the calculated third parameter by using the previous commands (a history of the commands) stored in the third storage unit 23. More specifically, when the third parameter is calculated by the fifth calculator 19, the second corrector 24 can correct the calculated third parameter in such a manner that the value of the third parameter of the command vector corresponding to the commands issued in the past increases. For example, the second corrector 24 adds, to the third parameter calculated by the fifth calculator 19, a bias value by which the value of the third parameter of the command vector corresponding to the command that is last issued increase, thereby being capable of correcting the calculated third parameter. Alternatively, the second corrector 24 adds, to the third parameter calculated by the fifth calculator 19, a bias value by which the value of the third parameter of each of the command vectors other than the command vector corresponding to the command that is last issued decrease, thereby being capable of correcting the calculated third parameter.

From the above, if a specific command is issued first in the case where the specific command is repeatedly issued, for example, the specific command is easy to be issued afterwards. Specifically, it is easy for even a small hand waving action or a hand waving action near the reference position to issue the specific command, whereby a continuous scroll motion can more easily be made.

For example, even when the user moves his/her hand near the reference position to make the returning action, whereby the inner product between the position vector and the command vector in the direction reverse to the direction of the specific command vector is changed to a plus value, a bias value by which the value of the third parameter of the command vector corresponding to the specific command (the command that is issued last) increases is added to the calculated value of the third parameter of the command vector in the reverse direction. Specifically, the third parameter of each of the command vectors other than the command vector corresponding to the specific command is corrected (is suppressed to be low) in order to prevent the third parameter from having a value equal to or larger than the threshold value, which prevents the returning action from being erroneously recognized as the command in the reverse direction.

Alternatively, the second corrector 24 adds a bias value according to the number of issuances of each command during the predetermined period in the past to the third parameter calculated by the fifth calculator 19, thereby being capable of correcting the calculated third parameter. For example, the second corrector 24 adds, to the third parameter calculated by the fifth calculator 19, a bias value by which the value of the third parameter of the command vector, corresponding to the command that is issued most during the predetermined period in the past, increase, thereby being capable of correcting the calculated third parameter. Still alternatively, the second corrector 24 adds, to the third parameter calculated by the fifth calculator 19, a bias value by which the value of the third parameter of each of the command vectors other than the command vector corresponding to the command that is issued most during the predetermined period in the past decreases, thereby being capable of correcting the calculated third parameter. With this process, the command that is issued many times is easy to be issued, while the other commands are difficult to be issued. Accordingly, when a specific command is repeatedly issued, for example, the specific command is easy to be issued (because this command is issued many times), while another command corresponding to the command vector in the direction reverse to the direction of the command vector of the specific command due to the returning action of the user is difficult to be issued.

The flowchart illustrating an example of the process operation performed by the command issuing apparatus 300 according to the third embodiment is the same as that illustrated in FIG. 6. In step S10 in FIG. 6, the second corrector 24 executes the above-mentioned correcting process to the third parameter calculated in step S9.

### Fourth Embodiment

The fourth embodiment will next be described. The fourth embodiment is different from the first embodiment in that an input state of a command according to the third parameter calculated by the fifth calculator 19 is displayed. The same components as those in the first embodiment are identified by the same numerals and the description will not be repeated in some cases.

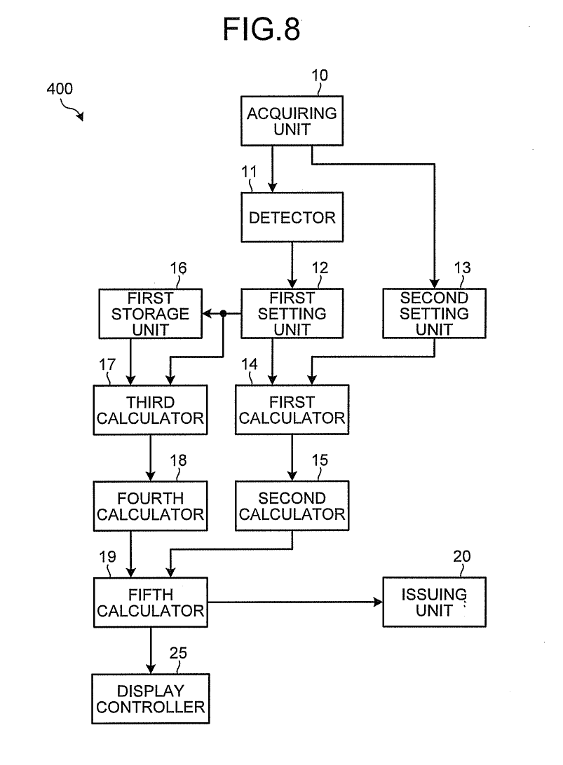

FIG. 8 is a block diagram illustrating a configuration example of a command issuing apparatus 400 according to the fourth embodiment. As illustrated in FIG. 8, the command issuing apparatus 400 further includes a display controller 25. Every time the fifth calculator 19 calculates the third parameter, the display controller 25 controls a display device (not illustrated) such as a liquid crystal display to display an input state of the command corresponding to the calculated third parameter. The value of the third parameter may be displayed as the input state of the command. Considering the difference in the scale between the third parameter and the command input state, a value indicating the command input state can be calculated by using a linear function indicating the relationship between the third parameter and the command input state. A quadratic function indicating the relationship between the third parameter and the command input state can be used to suppress the increase in the value indicating the command input state when the value of the third parameter is low, which prevents the value of the third parameter from being changed to an unintentional value. The relationship between the third parameter and the command input state may be represented by an exponential function, sigmoid function, or kernel function (e.g., Gaussian kernel) in order to make an animation displayed on the display device smooth, whereby the value indicating the command input state can be calculated. The value indicating the command input state can also be calculated by using a combination of the above-mentioned functions.

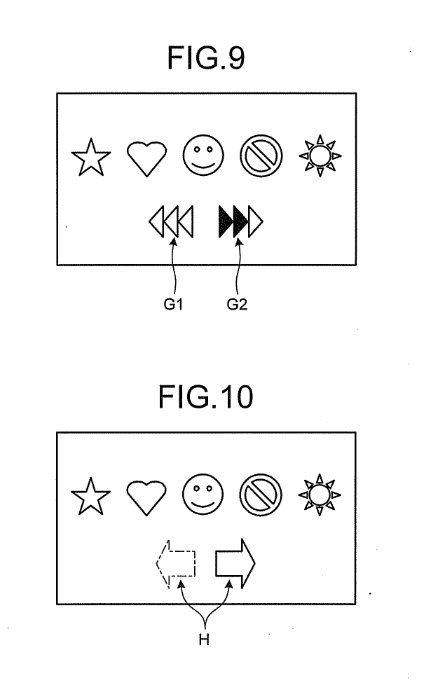

Any method may be employed as the method of displaying the command input state. For example, a gauge may be increased or decreased according to the value of the third parameter as illustrated in FIG. 9. In the example in FIG. 9, two types of gauges are illustrated, in which one gauge G1 corresponds to the command of the command vector Vd1 in FIG. 2, while the other gauge G2 corresponds to the command vector Vd2 in FIG. 2. In the example in FIG. 9, as the value of the third parameter of the command vector Vd1 is close to the threshold value, the number of the colored gauges G1 increases, and as it is lower than the threshold value, the number of the colored gauges G1 decreases. For example, when the value of the third parameter of the command vector Vd1 is equal to or larger than the threshold value, all gauges G1 are displayed as colored. Similarly, as the value of the third parameter of the command vector Vd2 is closer to the threshold value, the number of the colored gauges G2 increases, and as it is lower than the threshold value, the number of the colored gauges G2 decreases. With this process, the user can easily find the input state of each command.

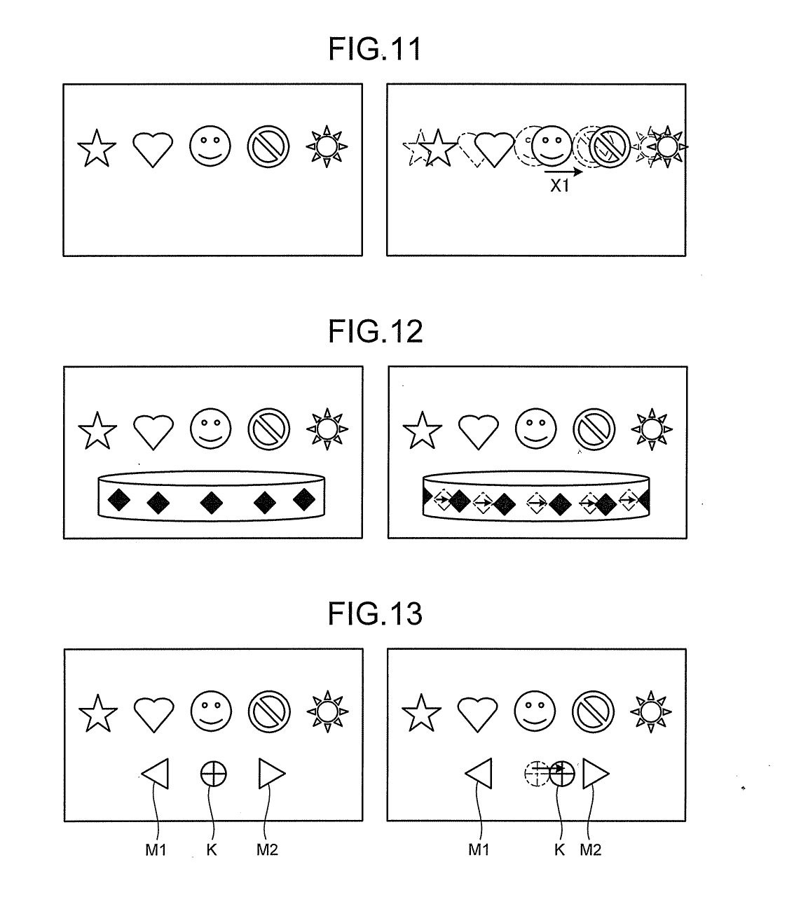

A display method illustrated in FIG. 10 may be employed. In the display method, when the value of the third parameter corresponding to a predetermined command (command vector) is equal to or larger than a threshold value, an icon H corresponding to the predetermined command may be displayed, and when it is less than the threshold value, the icon H may not be displayed. Alternatively, a display method in which an icon moves in a specific direction according to the input state of the command may be employed as illustrated in FIG. 11. For example, when the command vector Vd2 in FIG. 2 is a feeding command for moving the icon in a direction of X1 in FIG. 11, the icon may move in the X1 direction if the value of the third parameter of the command vector Vd2 is equal to or larger than the threshold value, but if the value of the third parameter of the command vector Vd2 is less than the threshold value, the icon cannot move in the X1 direction, and may return to the original position. Alternatively, a display method in which a ring icon rotates in a specific direction according to the input state of the command as illustrated in FIG. 12 may be employed.

Alternatively, a display method in which a cursor K displayed on the screen moves in a specific direction according to the input state of the command as illustrated in FIG. 13 may be employed. In the example in FIG. 13, an icon M1 of the command corresponding to the command vector Vd1 in FIG. 2 and an icon M2 of the command corresponding to the command vector Vd2 in FIG. 2 are displayed on the screen of the display device. When the cursor K is in contact with (or superimposed on) these icons, the command of the icon that is brought into contact with the cursor is issued. In the example in FIG. 13, when the value of the third parameter of the command vector Vd2 is larger than the value of the third parameter of the command vector Vd1, for example, the cursor K moves in the direction of the icon M2. When the value of the third parameter of the command vector Vd2 is equal to or larger than the threshold value, the cursor K is in contact with the icon M2, whereby the command corresponding to the command vector Vd2 is issued. Similarly, when the value of the third parameter of the command vector Vd1 is larger than the value of the third parameter of the command vector Vd2, the cursor K moves in the direction of the icon M1.

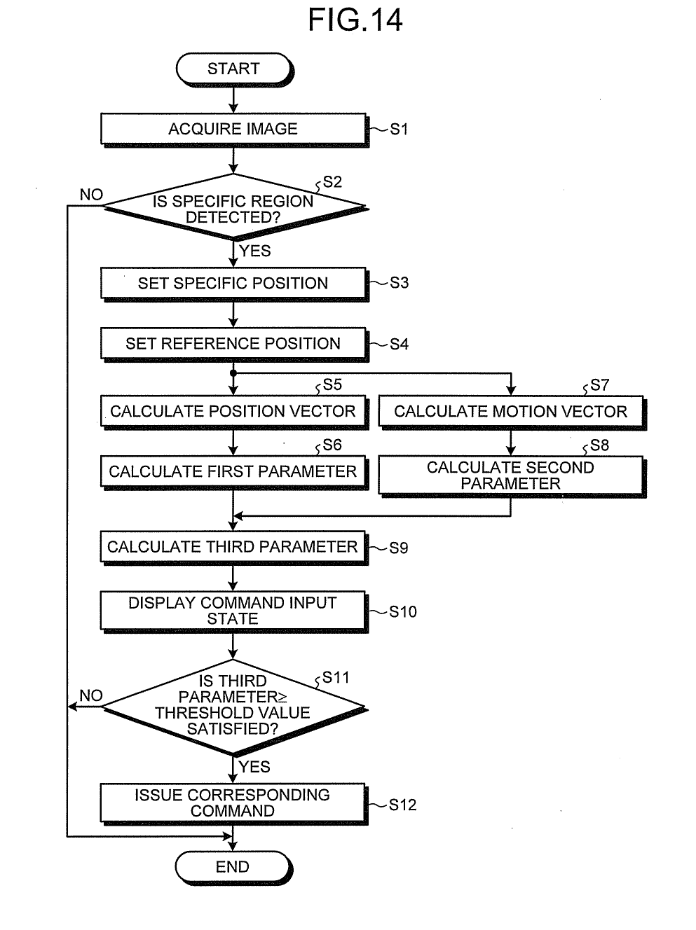

FIG. 14 is a flowchart illustrating an example of a process operation performed by the command issuing apparatus 400 according to the fourth embodiment. In the example in FIG. 14, the fourth embodiment is different from the first embodiment in that the display controller 25 executes the above-mentioned display control (step S10 in FIG. 6) for the third parameter calculated in step S9. The other processes are the same as those in the first embodiment.

The fourth embodiment described above can be combined with the second embodiment, or with the third embodiment. Specifically, the command issuing apparatus in each of the second and third embodiments can be provided with the display controller 25 described above.

Modifications

The embodiments described above have been presented by way of example only, and are not intended to limit the scope of the invention. Indeed, the novel embodiments may be embodied in a variety of other forms, and furthermore, a variety of omissions, substitutions, and changes in the form of the embodiments described herein may be made without departing from the scope of the present invention. The accompanying claims and their equivalents are intended to include such forms and modifications as would fall within the scope and spirit of the present invention. The modifications will be described below. Two or more of the following modifications may arbitrarily be combined.

(1) Modification 1

The type of the commands described above is arbitrary. For example, the command may be a feeding command for moving a cursor in a specific direction, or a feeding command for scrolling a screen in a specific direction. The command may also be the one for determining a specific selection item, or the one for canceling the specific selection item. The command may also be the one for executing a specific function such as audio or video playback. The command may also be the one for starting an application managing a multimedia, a television, or a TV program.

(2) Modification 2

In the third embodiment described above, the second corrector 24 corrects the calculated value of the third parameter by adding the bias value, by which the value of the third parameter of the command vector corresponding to the command (the command that is last issued, or the command that is issued most) issued in the past, to the third parameter calculated by the fifth calculator 19. Alternatively, the second corrector 24 can change the reference position in order that the value of the third parameter of the command vector corresponding to the command issued in the past increases. When the correction is to be made such that the value of the third parameter of the command vector Vd1 in FIG. 2 increases, for example, the second corrector 24 can shift the reference position in the direction reverse to the direction of the command vector Vd1. With this process, the position vector on the specific position with respect to the reference position increases more than that before the correction. Therefore, the value of the first parameter indicating the degree of coincidence between the command vector Vd1 and the position vector increases, whereby the value of the third parameter of the command vector Vd1 also increases. On the other hand, as for the command vector Vd2 in the direction reverse to the direction of the command vector Vd1, the value of the first parameter indicating the degree of the coincidence between the command vector Vd2 and the position vector decreases more than that before the correction, so that the value of the third parameter of the command vector Vd2 decreases.

(3) Modification 3

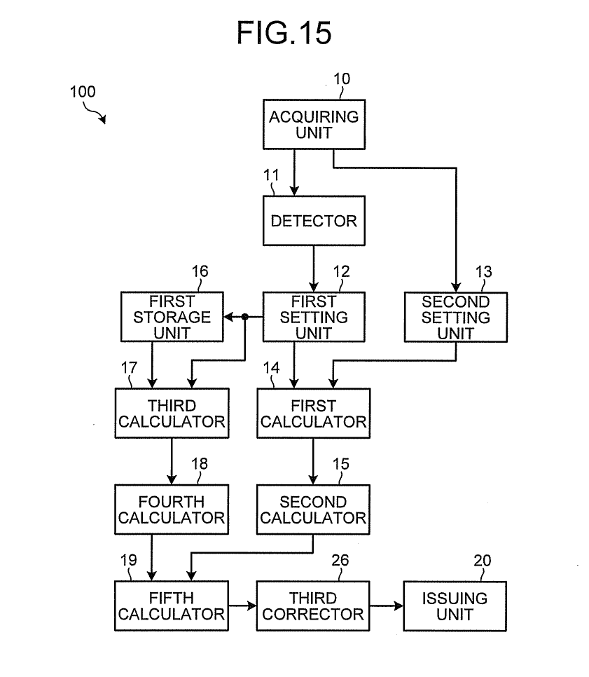

As illustrated in FIG. 15, the command issuing apparatus 100 according to the first embodiment can further be provided with a third corrector 26 for correcting the calculated third parameter value in order to prevent the third parameter calculated by the fifth calculator 19 from having a different value according to an imaging distance. For example, every time the third parameter is calculated by the fifth calculator 19, the third corrector 26 divides the calculated third parameter value by a correction value that is set to be a value according to an area value of at least part region of the subject displayed on the current frame. With this process, the third parameter calculated by the fifth calculator 19 is corrected so as not to have a different value according to the imaging distance.

Any value can be set as the correction value. For example, the area value of the specific region detected by the detector 11 can be set as the correction value. The area value of a predetermined region including the reference position set by the second setting unit 13 can also be set as the correction value, for example. When the shoulder position of the user in the frame is set as the reference position, the area value of the region including the shoulder width can be set as the correction value. When the face position of the user in the frame (e.g., the center coordinate in the face region) is set as the reference position, the area value of the user's face region can be set as the correction value.

For example, the correction value may also be set variable according to the area value of the specific region detected by the detector 11 and the shape of the specific region. More specifically, the area value of the specific region is corrected according to the shape of the specific region detected by the detector 11, and the corrected area value can be set as the correction value. For example, when the specific region is a user's hand, and the detected hand is an open hand (the palm is visible), the area value of the specific region may be corrected to be larger than the actual value (the correction value may be set to be large). When the detected hand is a first (the hand is closed), the area value of the specific region may be corrected to be smaller than the actual value (the correction value may be set to be small). This process can prevent the calculated third parameter from having a different value according to the current shape of the hand, when the user makes the same operation. Similarly, the correction value may be set variable according to the area value of the predetermined region including the reference position set by the second setting unit 13 and the shape of this region.

(4) Modification 4

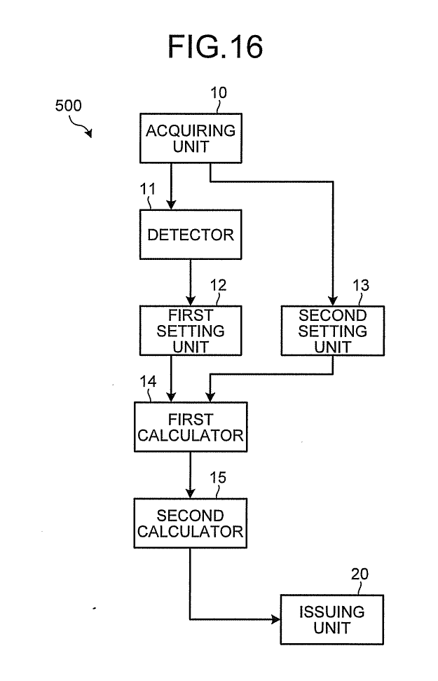

For example, it may be configured such that the command is issued only based upon the degree of coincidence between the command vector and the position vector without considering the degree of the coincidence between the command vector and the motion vector. FIG. 16 is a block diagram illustrating a configuration example of a command issuing apparatus 500 in this case. As illustrated in FIG. 16, the command issuing apparatus 500 is different from that in the first embodiment in that the command issuing apparatus 500 does not include the first storage unit 16, the third calculator 17, the fourth calculator 18, and the fifth calculator 19. In this case, the issuing unit 20 issues the command based upon the first parameter calculated by the second calculator 15. More specifically, when the value of the first parameter (in this example, the inner product of the command vector and the position vector) indicating the degree of coincidence between the command vectors and the position vector is equal to or larger than the threshold value, the issuing unit 20 issues the command corresponding to the command vector. Any value can be set as the threshold value. Even in the configuration in FIG. 16, if the degree of coincidence between the command vector and the position vector is low, the command corresponding to the command vector is difficult to be issued, as in the respective embodiments described above. Therefore, even when the user moves his/her hand in the direction of the command vector corresponding to the predetermined command in order to issue the predetermined command, and then, makes a returning action of returning his/her hand to the original position, the command corresponding to the command vector in the reverse direction is difficult to be issued, if the degree of coincidence between the command vector in the reverse direction and the position vector is low. Consequently, the issuance of the command, which the user does not intend to issue, by the returning action or the preliminary action, can be prevented.

Hardware Configuration and Program

The command issuing apparatus of each of the above-mentioned embodiments and modifications includes a control device such as a CPU (Central Processing Unit), a storage device such as ROM or RAM, an external storage device such as HDD or SSD, a display device such as a display, an input device such as a mouse or keyboard, and a communication device such as a communication I/F, which means the command issuing apparatus has a general hardware configuration utilizing a computer. The CPU of the command issuing apparatus develops and executes a program, stored in the ROM, on the RAM, whereby the functions of the acquiring unit 10, the detector 11, the first setting unit 12, the second setting unit 13, the first calculator 14, the second calculator 15, the third calculator 17, the fourth calculator 18, the fifth calculator 19, the issuing unit 20, the first corrector 22, the second corrector 24, the display controller 25, and the third corrector 26 can be realized. The invention is not limited thereto. At least some of these functions can be realized by an individual circuit (hardware). The first storage unit 16, the second storage unit 21, and the third storage unit 23 are elements realized by the hardware, and included in the storage device or in the external storage device.

A program executed in the command issuing apparatus in each of the embodiments and modifications may be stored on a computer connected to the network such as the Internet, and provided as being downloaded through the network. The program executed in the command issuing apparatus in each of the embodiments and modifications may be provided or distributed through the network such as the Internet. The program executed in the command issuing apparatus in each of the embodiments and modifications may be provided as being installed on the ROM beforehand. So long as the command issuing apparatus according to each of the embodiments described above includes a control device such as a CPU and a storage device, and processes an image acquired from an imaging device, it can be applied not only to a PC (Personal Computer) but also to a TV.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A command issuing apparatus comprising:
an acquiring unit configured to acquire an image obtained by capturing a subject;
a detector configured to detect a specific region of the subject from the image;
a first setting unit configured to set a specific position indicating a position of the specific region;
a second setting unit configured to set a reference position indicating a position that is to be a reference in the image;
a first calculator configured to calculate a position vector directing toward the specific position from the reference position;
a second calculator configured to calculate, for each of a plurality of command vectors respectively corresponding to predetermined commands, a first parameter indicating a degree of coincidence between the command vector and the position vector; and
an issuing unit configured to issue the command based on the first parameter.

2. The apparatus according to claim 1, further comprising:
a first storage unit configured to store therein the specific position of each of the images acquired by the acquiring unit in chronological order;
a third calculator configured to calculate a motion vector representing a moving direction and a moving amount of the specific region based on a history of the specific positions stored in the first storage unit; and
a fourth calculator configured to calculate, for each of the command vectors, a second parameter indicating a degree of coincidence between the command vector and the motion vector, wherein
the issuing unit issues the command based on the first parameter and the second parameter.

3. The apparatus according to claim 2, wherein
the first parameter is an inner product of the position vector and the command vector, and
the second parameter is an inner product of the motion vector and the command vector, and
the apparatus further comprises a fifth calculator configured to calculate, for each of the command vectors, a third parameter to have a higher value, as values of the first parameter and the second parameter are larger, by using the first parameter and the second parameter of the command vector, wherein
the issuing unit issues, for each of the command vectors, the command corresponding to the command vector, when the third parameter of the command vector is equal to or larger than a threshold value.

4. The apparatus according to claim 3, further comprising:
a second storage unit configured to store therein the third parameter; and
a first corrector unit configured to correct the third parameter calculated by the fifth calculator based on a history of the third parameter stored in the second storage unit.

5. The apparatus according to claim 3, further comprising:
a third storage unit configured to store therein the command issued by the issuing unit; and
a second corrector configured to correct the third parameter calculated by the fifth calculator based on a history of the command stored in the third storage unit.

6. The apparatus according to claim 5, wherein
the second corrector corrects the third parameter calculated by the fifth calculator in such a manner that the third parameter of the command vector corresponding to the command issued in past increases.

7. The apparatus according to claim 6, wherein
the second corrector changes the reference position in such a manner that the third parameter of the command vector corresponding to the command issued in past increases.

8. The apparatus according to claim 3, further comprising:
a third corrector configured to correct the third parameter calculated by the fifth calculator in such a manner that the calculated third parameter does not have a different value according to an imaging distance.

9. The apparatus according to claim 8, wherein
the third corrector divides the third parameter calculated by the fifth calculator by a correction value that is set according to an area value of at least part region of the subject.

10. The apparatus according to claim 9, wherein
the correction value is an area value of the specific region detected by the detector.

11. The apparatus according to claim 9, wherein
the correction value is set variable according to an area value of the specific region detected by the detector and a shape of the specific region.

12. The apparatus according to claim 9, wherein
the correction value is an area value of a predetermined region including the reference position.

13. The apparatus according to claim 9, wherein
the correction value is set variable according to an area value of a predetermined region including the reference position and a shape of the predetermined region.

14. The apparatus according to claim 2, further comprising:
a display controller configured to control a display device to display an input state of the command corresponding to the third parameter calculated by the fifth calculator.

15. A command issuing method comprising:
acquiring an image obtained by capturing a subject;
detecting a specific region of the subject from the image;
setting a specific position indicating a position of the specific region;
setting a reference position indicating a position that is to be a reference in the image;
calculating a position vector directing toward the specific position from the reference position;
calculating, for each of a plurality of command vectors respectively corresponding to predetermined commands, a first parameter indicating a degree of coincidence between the command vector and the position vector; and
issuing the command based on the first parameter.

16. A computer-readable medium including program instructions, wherein the instructions, when executed by a computer, cause the computer to execute:
acquiring an image obtained by capturing a subject;
detecting a specific region of the subject from the image;
setting a specific position indicating a position of the specific region;
setting a reference position indicating a position that is to be a reference in the image;
calculating a position vector directing toward the specific position from the reference position;
calculating, for each of a plurality of command vectors respectively corresponding to predetermined commands, a first parameter indicating a degree of coincidence between the command vector and the position vector; and
issuing the command based on a the first parameter.
